(19) United States
(12) Patent Application Publication
(10) Pub. No.: US 2010/0103911 A1
(43) Pub. Date: Apr. 29, 2010

(54) Apparatus and method providing an IEEE-802.16 self-organizing network

(75) Inventor: Baowei Ji, Plano, TX (US)

Correspondence Address: DOCKET CLERK, P.O. DRAWER 800889, DALLAS, TX, 75380, US

(73) Assignee: Samsung Electronics, Co., Ltd., Suwon-si (KR)

(21) Appl. No.: 12/387,670

(22) Filed: May 6, 2009

Related U.S. Application Data
(60) Provisional application No. 61/197,564, filed on Oct. 27, 2008.

(51) Int. Cl. H04W 84/02

(52) U.S. Cl. 370/338

(57) ABSTRACT

Systems and methods are disclosed that include a receiver configured to receive a command message a controller configured to interpret the command message. The controller is also configured to perform a scan according to the command message using the receiver. The controller can also transmit a report message based upon one or more parameters within the command message using a transmitter. In some systems and methods, the report message comprises information related to contention within the wireless network.

### CROSS-REFERENCE TO RELATED APPLICATION(S) AND CLAIM OF PRIORITY

The present application is related to U.S. Provisional Patent No. 61/197,654, filed Oct. 28, 2008, entitled “METHOD AND MAC MESSAGE FORMAT FOR SELF ORGANIZING NETWORK”. Provisional Patent No. 61/197,654 is assigned to the assignee of the present application and is hereby incorporated by reference into the present application as if fully set forth herein. The present application hereby claims priority under 35 U.S.C. §119(e) to U.S. Provisional Patent No. 61/197,654.

### TECHNICAL FIELD OF THE INVENTION

The present application relates generally to communication networks, and more specifically, to self organizing networks.

### BACKGROUND OF THE INVENTION

Self-organizing network devices (hereinafter, “SON devices”) are devices that make up a self-organizing network. The term “self-organizing network” refers to a communications signal relaying system that enables passive relaying of signals between at least two external nodes communicably connected to the self-organizing network. A self-organizing network can have a mesh, star, cluster, or other type of topology.

One of the problems with SON networks is the difficulty in configuring and setting the SON devices. Systems and methods that could be used to configure SON networks are needed.

### SUMMARY OF THE INVENTION

In one embodiment, a system for configuring a network is provided. This system includes a receiver configured to receive a command message and a controller configured to interpret the command message. The controller is also configured to perform a scan according to the command message using the receiver. In addition, the controller can also transmit a report message based upon one or more parameters within the command message using a transmitter. In some systems, the report message comprises information related to contention within the wireless network.

In another embodiment, a system is disclosed that includes a network device. This system includes a controller configured to compose a command message with a plurality of parameters and transmit the command message using a transmitter. This command message may provide instructions that allow another device to obtain information about a wireless network. This system also includes a receiver configured to receive a response from the command message and send the response to the controller. Also in this system the controller is configured to alter the contention of the network based upon the response and transmit a report message based upon a configuration of the wireless network.

In yet another embodiment, a method of operating a wireless network capable of self configuration is disclosed. This method includes creating a command message at a source and transmitting the command message to at least one destination. This method also includes interpreting the command message at the at least one destination, performing a scan based upon the command message at the at least one destination, and creating a report based upon the results of the scan. In addition, this method also includes transmitting the report to the source.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary wireless network that transmits messages in the uplink according to the principles of the present disclosure.

FIG. 2A is a high-level diagram of an orthogonal frequency division multiple access (OFDMA) transmit path.

FIG. 2B is a high-level diagram of an orthogonal frequency division multiple access (OFDMA) receive path.

FIG. 3 illustrates a call flow diagram according to an exemplary embodiment of the disclosure.

FIG. 4 is a table comprising information related command messages according to an exemplary embodiment of the disclosure.

FIG. 5 is a table comprising information related to flags in a command message according to an exemplary embodiment of the disclosure.

FIG. 6 is a table comprising information related to a response message according to an exemplary embodiment of the disclosure.

FIG. 7 is a table comprising information related to a report message according to an exemplary embodiment of the disclosure.

FIG. 8 is a flowchart illustrating one method of setting up a SON network according to an exemplary embodiment of the disclosure.

### DETAILED DESCRIPTION OF THE INVENTION

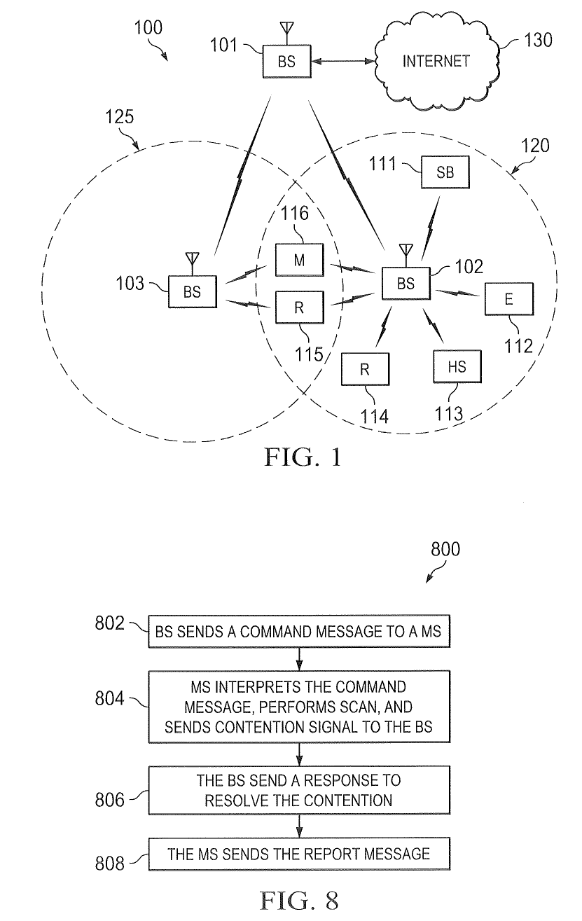

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

FIG. 1 illustrates exemplary wireless network 100, which transmits messages according to the principles of the present disclosure. In the illustrated embodiment, wireless network 100 includes base station (BS) 101, base station (BS) 102, base station (BS) 103, and other similar base stations (not shown). Base station 101 is in communication with base station 102 and base station 103. Base station 101 is also in communication with Internet 130 or a similar IP-based network (not shown).

Base station 102 provides wireless broadband access (via base station 101) to Internet 130 to a first plurality of mobile stations within coverage area 120 of base station 102. The first plurality of mobile stations includes mobile station 111, which may be located in a small business (SB), mobile station 112, which may be located in an enterprise (E), mobile station 113, which may be located in a WiFi hotspot (HS), mobile station 114, which may be located in a first residence (R), mobile station 115, which may be located in a second residence (R), and mobile station 116, which may be a mobile device (M), such as a cell phone, a wireless laptop, a wireless PDA, or the like.

Base station 103 provides wireless broadband access (via base station 101) to Internet 130 to a second plurality of mobile stations within coverage area 125 of base station 103. The second plurality of mobile stations includes mobile station 115 and mobile station 116. In an exemplary embodiment, base stations 101-103 may communicate with each other and with mobile stations 111-116 using OFDM or OFDMA techniques.

Base station 101 may be in communication with either a greater number or a lesser number of base stations. Furthermore, while only six mobile stations are depicted in FIG. 1, it is understood that wireless network 100 may provide wireless broadband access to additional mobile stations. It is noted that mobile station 115 and mobile station 116 are located on the edges of both coverage area 120 and coverage area 125. Mobile station 115 and mobile station 116 each communicate with both base station 102 and base station 103 and may be said to be operating in handoff mode, as known to those of skill in the art.

Mobile stations 111-116 may access voice, data, video, video conferencing, and/or other broadband services via Internet 130. In an exemplary embodiment, one or more of mobile stations 111-116 may be associated with an access point (AP) of a WiFi WLAN. Mobile station 116 may be any of a number of mobile devices, including a wireless-enabled laptop computer, personal data assistant, notebook, handheld device, or other wireless-enabled device. Mobile stations 114 and 115 may be, for example, a wireless-enabled personal computer (PC), a laptop computer, a gateway, or another device.

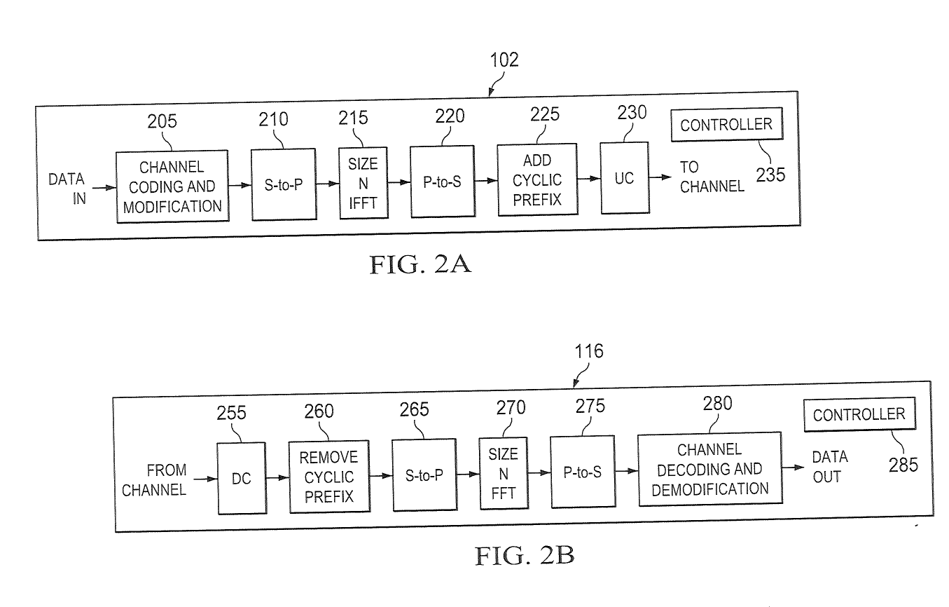

FIG. 2A is a high-level diagram of an orthogonal frequency division multiple access (OFDMA) transmit path. FIG. 2B is a high-level diagram of an orthogonal frequency division multiple access (OFDMA) receive path. In FIGS. 2A and 2B, the OFDMA transmit path is implemented in base station (BS) 102 and the OFDMA receive path is implemented in mobile station (SS) 116 for the purposes of illustration and explanation only. However, it will be understood by those skilled in the art that the OFDMA receive path may also be implemented in BS 102 and the OFDMA transmit path may be implemented in SS 116.

The transmit path in BS 102 comprises channel coding and modulation block 205, serial-to-parallel (S-to-P) block 210, Size N Inverse Fast Fourier Transform (IFFT) block 215, parallel-to-serial (P-to-S) block 220, add cyclic prefix block 225, up-converter (UC) 230. The receive path in SS 116 comprises down-converter (DC) 255, remove cyclic prefix block 260, serial-to-parallel (S-to-P) block 265, Size N Fast Fourier Transform (FFT) block 270, parallel-to-serial (P-to-S) block 275, channel decoding and demodulation block 280.

At least some of the components in FIGS. 2A and 2B may be implemented in software while other components may be implemented by configurable hardware or a mixture of software and configurable hardware. In particular, it is noted that the FFT blocks and the IFFT blocks described in this disclosure document may be implemented as configurable software algorithms, where the value of Size N may be modified according to the implementation.

Furthermore, although this disclosure is directed to an embodiment that implements the Fast Fourier Transform and the Inverse Fast Fourier Transform, this is by way of illustration only and should not be construed to limit the scope of the disclosure. It will be appreciated that in an alternate embodiment of the disclosure, the Fast Fourier Transform functions and the Inverse Fast Fourier Transform functions may easily be replaced by Discrete Fourier Transform (DFT) functions and Inverse Discrete Fourier Transform (IDFT) functions, respectively. It will be appreciated that for DFT and IDFT functions, the value of the N variable may be any integer number (i.e., 1, 2, 3, 4, etc.), while for FFT and IFFT functions, the value of the N variable may be any integer number that is a power of two (i.e., 1, 2, 4, 8, 16, etc.).

FIG. 2A also shows controller 235, and FIG. 2B also shows controller 285. Controller 235 and 285 may be configured to control the various elements of FIGS. 2A and 2B, as well as configured to carry out other instructions consistent with this disclosure. Controller 235 and 285 may be implemented as a controller, a controller with a memory, or any other component capable of performing the functions of a controller.

In BS 102, channel coding and modulation block 205 receives a set of information bits, applies coding (e.g., Turbo coding) and modulates (e.g., QPSK, QAM) the input bits to produce a sequence of frequency-domain modulation symbols. Serial-to-parallel block 210 converts (i.e., de-multiplexes) the serial modulated symbols to parallel data to produce N parallel symbol streams where N is the IFFT/FFT size used in BS 102 and SS 116. Size N IFFT block 215 then performs an IFFT operation on the N parallel symbol streams to produce time-domain output signals. Parallel-to-serial block 220 converts (i.e., multiplexes) the parallel time-domain output symbols from Size N IFFT block 215 to produce a serial time-domain signal. Add cyclic prefix block 225 then inserts a cyclic prefix to the time-domain signal. Finally, up-converter 230 modulates (i.e., up-converts) the output of add cyclic prefix block 225 to RF frequency for transmission via a wireless channel. The signal may also be filtered at baseband before conversion to RF frequency.

The transmitted RF signal arrives at SS 116 after passing through the wireless channel and reverse operations to those at BS 102 are performed. Down-converter 255 down-converts the received signal to baseband frequency and remove cyclic prefix block 260 removes the cyclic prefix to produce the serial time-domain baseband signal. Serial-to-parallel block 265 converts the time-domain baseband signal to parallel time domain signals. Size N FFT block 270 then performs an FFT algorithm to produce N parallel frequency-domain signals. Parallel-to-serial block 275 converts the parallel frequency-domain signals to a sequence of modulated data symbols. Channel decoding and demodulation block 280 demodulates and then decodes the modulated symbols to recover the original input data stream.

Each of base stations 101-103 may implement a transmit path that is analogous to transmitting in the downlink to mobile stations 111-116 and may implement a receive path that is analogous to receiving in the uplink from mobile stations 111-116. Similarly, each one of mobile stations 111-116 may implement a transmit path corresponding to the architecture for transmitting in the uplink to base stations 101-103 and may implement a receive path corresponding to the architecture for receiving in the downlink from base stations 101-103.

The present disclosure relates to the use of a self-organizing network made up of one or more self-organizing network devices (hereinafter, “SON devices”). Self Organizing Network (SON) functions are intended for BSs (e.g. Macro, Relay, Femtocell) to automate the configuration of BS parameters and to optimize network performance, coverage and capacity. A self-organizing network can have a mesh, star, cluster, or other type of topology.

Deployment and operation of radio access networks become more and more an increasingly complex and cost extensive task for installation, maintenance and optimization of network nodes. First, a large quantity of sensitive radio access network configuration parameters have to be configured to initialize the radio base stations with a basic start-up configuration that allows the node to be switched to operational mode.

Second, in operational mode, various optimizations have to be carried out for achieving acceptable Quality of Service and good network efficiency. Both tasks currently are supported by network management tools but require a high degree of human interaction and intervention. Moreover, achieving good network efficiency requires experienced operators with high expertise to interpret system performance, performance indicators and measurements.

IEEE 802.16m should overcome these drawbacks through self-configuration and self-optimization procedures. The present disclosure is related to the creation of three medium access control (MAC) Management Messages (SON command (MOB_SON_CMD), SON Contention Resolution (MOB_SON_RSP), and SON Contention Report (MOB_SON_REP)), and discloses systems and methods for self organizing network (SON) functionality for wireless networks, including IEEE 802.16m.

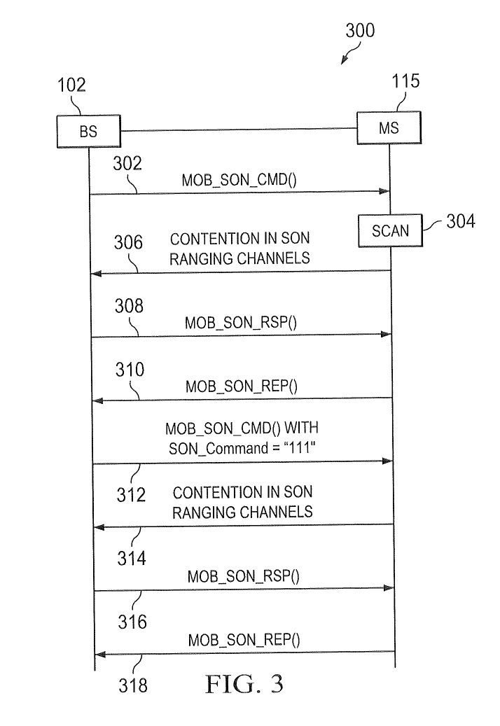

In one embodiment of the present disclosure, the BS 102 and the MS 115 may follow the message flow shown in FIG. 3 for neighbour discovery and self optimization. The message flow shown in FIG. 3 is between the single BS 102 and the single MS 115. However, it is explicitly understood that a similar flow may be used between any number of base stations and mobile stations.

In the flow diagram 300 of FIG. 3, the BS 102 uses a MOB_SON-CMD( ) message at flow 302 to instruct the MS 115 to scan for neighbour base stations at flow 304. The MOB_SON-CMD( ) message at flow 302 may indicate what information an MS should scan for, such as traffic load, paging area ID, signal level, EMBS configuration, preamble sequence number, and/or the entire SI (system information). The BS 102 also indicates whether cell-wide quiet period is used for co-channel scan.

At flow 306, having finished the scan at flow 304, the MS 115 performs contention in SON ranging channels by sending a ranging code in a ranging transmission opportunity (TXOP) following the contention rule stipulated in the MOB_SON-CMD( ) message from the BS 102. For the purpose of clarity, contention is intended to refer to the ability of allowing several MSs and BSs to use the radio chaos without pre-coordination through methods such as the “listen before transmitting protocol”. Specific information relating to the implementation of a contention channel may be found in Section 90.7, part 90 of the United States Federal Communication Rules, which states (referring to contention) that a contention protocol “allows multiple users to share the same spectrum by defining the events that must occur when two or more transmitters attempt to simultaneously access the same channel and establishing rules by which a transmitter provides reasonable opportunities for other transmitters to operate. Such a protocol may consist of procedures for initiating new transmissions, procedures for determining the state of the channel (available or unavailable), and procedures for managing retransmissions in the event of a busy channel.”

The BS 102 resolves the contention at flow 308 by sending a response message MOB_SON-RSP( ) listing each identified ranging code and the corresponding UL burst allocation. In some embodiments, the UL allocation and the format of the report message MOB_SON-RSP( ) is derived from the previous MOB_SON-CMD( ) message transmitted at flow 302. In other embodiments, having received some reports, the BS 102 sends a short version of the MOB_SON-CMD( ) message in a MOB_SON_REP message listing all the BSs already detected at flow 310. The MS 115 will contend only if the MS 115 has information for BSs that are not listed in the MOB_SON-CMD( ) message.

There could be a certain indicator in the broadcasting channel (BCH) to indicate whether the cell is in SON operation or not. The present disclosure also provides a way for combining this indicator with the MOB_SON-MCD( ) message transmitted at flow 302.

In some embodiments, during the first SON operation, the BS indicates that no traffic data is supported at that time so that all radio resources can be used for finishing the self organizing of the BS. In other embodiments, the BS should not interrupt regular traffic communication during periodic or on-demand SON.

It is further understood that the MOB_SON_CMD message at flow 302 may be used to instruct the MS 115 to detect any type of neighbour communication device including, but not limited to, neighbour communication devices operating using the 802.16m or 802.16e standard.

In some embodiments, at flow 312, the BS 102 may use a short version of the MOB_SON-CMD( ) message that includes all the fields up to and including Contention_Window_size with a unique value, such as a value of of “111”, for the SON_Operation_Mode during subsequent contention sessions. This message lists all the neighbour base stations already known to the BS 102 so that no further report is needed for them. Therefore, the MS 115 contends for further report opportunities only if the MS 115 has results for BSs that are not already in the list. The call flow 312 following the MOB_SON-CMD( ) message at flow 312 illustrates contention in SON ranging channels, which is similar to the contention in SON ranging channels at flow 306 discussed above. In addition, this flow diagram also comprises a MOB_SON_RSP ( ) message at flow 316 which is similar to the MOB_SON_RSP ( ) message at flow 308, and a MOB_SON_REP( ) message at 316 which is similar to the MOB_SON_REP( ) message at flow 318.

In some embodiments, the BS 102 stipulates the contention method for the MS 115 to report measurement results. In one example, the BS 102 has allocated K ranging transmission opportunities (TXOP), and the MS 115 has found N neighbour BSs. The MS 115 could contend N times among each of the K TXOPs, contend in a TXOP that equals BSID % K, or contend in a TXOP that equals (MSID+n) % K where n=0, 1, . . . N. The MS 115 contends by randomly picking up an integer number in the range of [0, Contention_Window_size], and sends the ranging code in the selected TXOP if the random number equals zero. Otherwise, the MS 115 reduces the random number by one and contends again in the next proper TXOP unless the BS 102 indicates no report is needed for a specific base station.

The BS 102 resolves the contention by listing the ranging codes together with the TXOPs where each ranging code was identified. The identified ranging codes are listed in the MOB_SON-RSP( ) 306, 318 message. Each ranging code corresponds to an UL burst for the MS 115 to send the measurement report. Multiple ranging codes may belong to the same MS 115 if it has detected multiple neighbor BSs. The allocation of UL burst for the MS 115 to send MOB_SON-REP( ) corresponds to the order of the RangingCodeIDs in the list, e.g., the first RangingCodeID corresponds to the first UL burst for the MS 115 to send the report message. The allocation of UL burst resource and message format of the MOB_SON-REP( ) 310, 318 shall be derived from the previous MOB_SON-CMD( ) 302, 312.

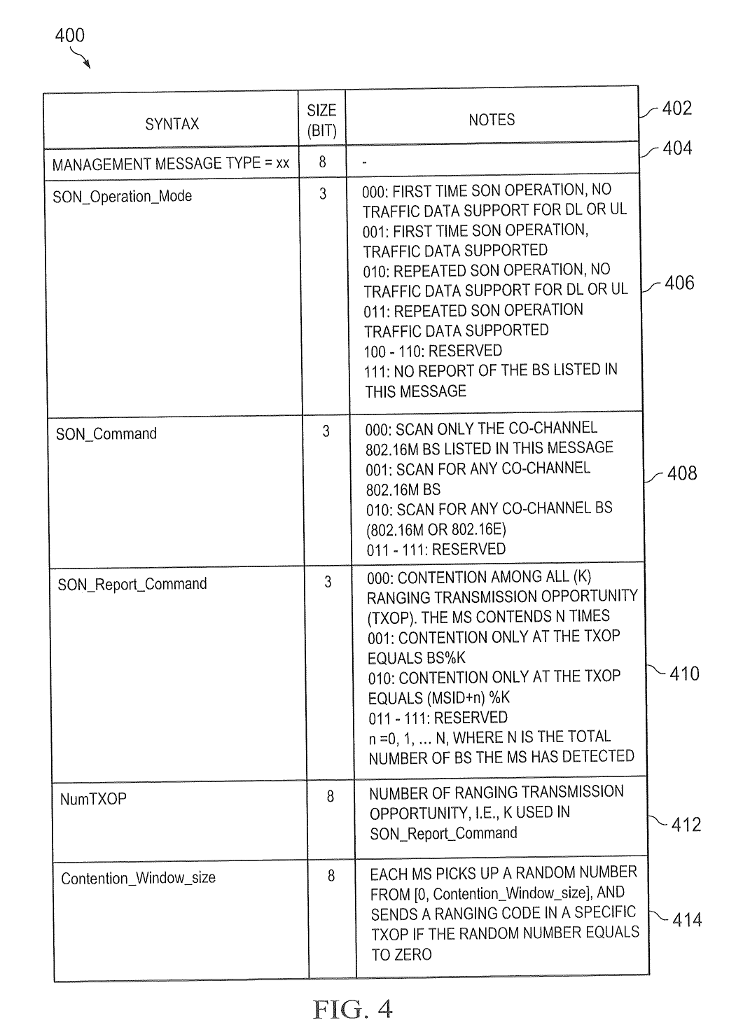

FIG. 4 is a table 400 of one embodiment of the the MOB_SON-CMD (302) message format. In this figure, row 402 shows that the syntax, size, and notes relating to each part of the MOB_SON-CMD message are shown. Row 404 indicates the management message type. The management type message may comprise up to 8 bits.

Row 406 indicates the SON_Operation_Mode. The operational mode is selected based upon the content of three bits as indicated below:
000: First time SON operation, no traffic data support for DL or UL.
001: First time SON operation, traffic data supported.
010: Repeated SON operation, no traffic data support for DL or UL.
011: Repeated SON operation, traffic data supported.
100-110: Reserved
111: No report of the BS listed in this message

Row 408 shows an instruction by the BS 102 issued to at least one MS, such as MS 115, indicating the scanning parameters. This command may be three bits in length. Examples of this command may appear are indicated below:
000: Scan only the co-channel 802.16m BS listed in this message
001: Scan for any co-channel 802.16m BS
010: Scan for any co-channel BS (802.16m or 802.16e)
111: Scan for any BS in any channels
011-110: Reserved

Row 410 shows an instruction from the BS 102 to the MS 115 indicating how to report contention results. This command may be three bits in length. Examples of this command are reproduced below:
000: contention among all (K) ranging transmission opportunity (TXOP). The MS contends N times.
001: contention only at the TXOP equals BS % K
010: contention only at the TXOP equals (MSID+n) % K
011-111: Reserved
n=0, 1, . . . N, where N is the total number of BS the MS has detected.

Row 412 shows an instruction from the BS 102 to the MS 115 indicating the ranging transmission opportunity. This instruction may be related to the number of ranging transmission opportunities (e.g., K as used in contention for MSs to send SON Report Messages) and may be eight bits in length. The Contention_Window_size is given in row .414. This field is 8 bits, and each MS 115 picks a random contain size in this field. If the random number is equal to zero, a specific TXOP message is sent.

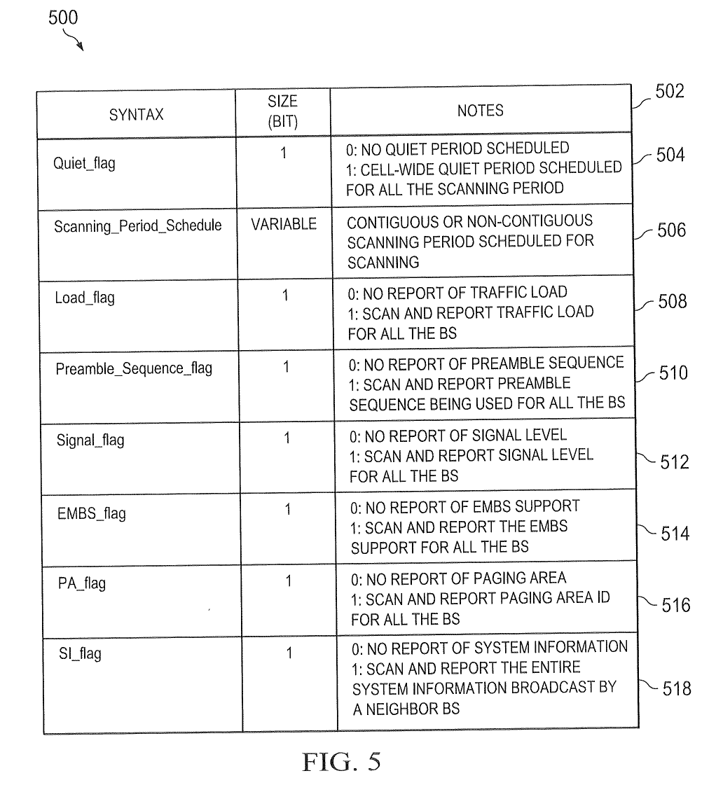

FIG. 5 is a table 500 of flags and indicators that may be sent with the MOB_SON-CMD( ) message at flow 302. In this table, row 502 shows that the table contains the syntax, size, and notes for each field. Row 504 relates to a quiet flag that indicates whether a cell wide quiet period is scheduled. Row 506 relates to the scanning period schedule, and indicates if contiguous or non-contiguous scanning is scheduled. Row 508 relates to traffic load and indicates if the traffic load should be reported by the MS 115 to the BS 102. Row 510 shows the preamble sequence flag, which indicates if there is a preamble sequence being used for all BSs.

Row 512 indicates whether the signal level should be reported by the MS 115, and row 514 indicates the availability of EMBS support. Row 516 indicates whether the paging area should be reported, and row 518 indicates whether there should be a system information report from the MS 115 to the BS 102.

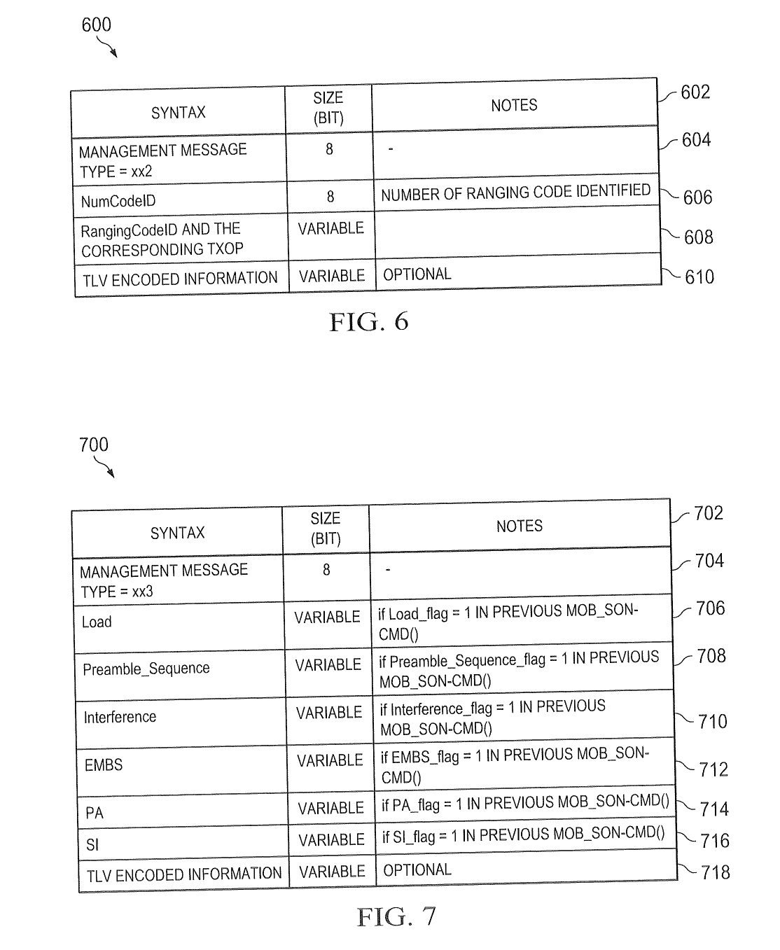

FIG. 6 is a table 600 of an example of the MOB_SON-RSP message format. In this table, row 602 shows that the table contains the syntax, size, and notes for each field. Row 604 shows the management message type. The number of the ranging code (NumCodeID) is shown in row 606. The actual transmitted ranging code ID and the TXOP where this ranging code ID was identified is shown in row 608. In addition, there may be additional information, such as the information discussed in FIG. 5, transmitted in the TLV encoded information using row 610.

FIG. 7 is a table of an example the SON report message (i.e., MOB_SON-REP message). In this table, row 702 shows that the table contains the syntax, size, and notes for each field. The management message type is shown in row 704. If the load flag was present in the previous MOB_SON-CMD( ) message (i.e., Load_flag=1 in MOB_SON-CMD( ) message), then the Load information is included in row 706. If the preamble sequence was present in the previous MOB_SON-CMD( ) message, then the Preamble_Sequence information would be present at row 708. If the interference flag was present in the previous MOB_SON-CMD( ) message, then the Interference information would be present at row 710. If the EMBS flag was present in the previous MOB_SON-CMD( ) message, then the EMBS information would be present at row 712. If the paging area flag was present in the previous MOB_SON-CMD( ) message, then the Paging Area codes would be present at row 714. If the system information flag was present in the previous MOB_SON-CMD( ) message, then the system information would be present at row 716. In addition, there may be additional information, such as the information discussed in FIG. 5, transmitted in the TLV encoded information using row 718.

FIG. 8 is a flowchart 800 illustrating one method of implementing the present disclosure. In block 802, the BS 102 sends a command message to the MS 115. In block 804, the MS interprets the command message, performs a scan, and sends a contention to the BS 102. In block 806, the BS 102 sends a contention resolution message to the MS 115. In block 808, the MS 115 sends a report message to the BS 102.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. For use in a wireless network, a wireless device comprising:
a receiver configured to receive a command message, wherein the command message comprises information related to information known by a sender and at least one request for information by the sender; and
a controller configured to interpret the command message, perform a scan according to the command message using the receiver, and transmit a report message based upon one or more parameters within the command message using a transmitter to the sender,
wherein the report message comprises information related to contention within the wireless network.

2. The wireless device as set forth in claim 1, wherein said report message comprises information related to the number of base stations detected by the wireless device during said scan.

3. The wireless device as set forth in claim 1, wherein the information is a short version of the MOB_SON-CMD( ) message.

4. The wireless device as set forth in claim 3, wherein the MOB_SON-CMD( ) message comprises information related to at least one element selected from the group consisting of: the channels to channels to be scanned, the period for a cell-wide scan, and contention schemes which may be used.

5. The wireless device as set forth in claim 3, wherein there is -an implicit mapping between a ranging code ID and the uplink resource grants to send a MOB_SON-REP( ).

6. The wireless device as set forth in claim 5, wherein format of the MOV_SON( )-REP message is derived automatically from the previous MOB_SON-CMD( ) message.

7. The wireless device as set forth in claim 6, wherein the MOB_SON-CMD message comprises a value of 1 for a load_flag message, and in response to the value of 1 for the load_flag message the MOB_SON-REP( ) automatically includes the load information.

8. The wireless device as set forth in claim 1, wherein said report message comprises uplink and downlink information.

9. The wireless device as set forth in claim 1, wherein said report message comprises a plurality of channels.

10. A network device comprising:
a controller configured to create a command message and transmit the command message using a transmitter, wherein the command message is in the form of a MOB_SON-CMD( ) message that comprises information indicating what data is known to the controller and what information is requested by the controller; and
a receiver configured to receive a response from the command message and send the response to the controller, wherein the controller configures the contention of the network based upon the response.

11. The network device as set forth in claim 10, wherein the MOB_SON-CMD( ) message comprises information related to at least one element selected from the group consisting of: the channels to channels to be scanned, the period for a cell-wide scan, and contention schemes which may be used.

12. The network device as set forth in claim 10, wherein the MOB_SON-CMD( ) message is a short MOB_SON-CMD( ) message.

13. The network device as set forth in claim 10, wherein said response message comprises uplink and downlink information.

14. The network device as set forth in claim 10, wherein the command message is sent to at least one mobile station.

15. The network device as set forth in claim 10, wherein the command message comprises information relating to a current configuration of the network.

16. The network device as set forth in claim 10, wherein the receiver receives a plurality of report messages.

17. A method of operating a wireless network capable of self configuration, the method comprising:
creating a command message at a source, wherein the command message comprises known and requested information, and wherein the command message comprises information related to at least one contention scheme;
transmitting the command message to at least one destination;
interpreting the command message at the at least one destination;
performing a scan based upon the command message at the at least one destination, wherein the type of scan to perform is indicated within the command message;
creating a report based upon the results of the scan, wherein the report uses implicit mapping between a rangingcodeID and the uplink resource grants, and wherein the format of the report is derived by using the command message; and
transmitting the report to the source.

18. The method as set forth in claim 17, wherein the source is a base station.

19. The method as set forth in claim 17, further comprising configuring the network using the report.

20. The method as set forth in claim 19, further comprising creating a response based upon the report at the source and transmitting the response to the destination.
